(19) United States
(12) Patent Application Publication
(10) Pub. No.: US 2008/0006164 A1
(43) Pub. Date: Jan. 10, 2008

(54) Offset rotary printing machine and method of adjusting angle of printing cylinders

(75) Inventors: Yoshiaki Kanda, Mihara (JP); Shigeo Makino, Hiroshima (JP); Nobukatsu Nishida, Otsu (JP)

Correspondence Address: KANESAKA BERNER AND PARTNERS LLP, 1700 DIAGONAL RD, SUITE 310, ALEXANDRIA, VA, 22314-2848, US

(73) Assignees: MITSUBISHI HEAVY INDUSTRIES, LTD., Tokyo (JP); ARAYA CO., LTD., Otsu (JP)

(21) Appl. No.: 11/808,954

(22) Filed: Jun. 14, 2007

(30) Foreign Application Priority Data
Jul. 4, 2006 (JP) 2006-184855

(51) Int. Cl. B41F 5/16; B41F 5/12; G05B 13/00

(52) U.S. Cl. 101/177; 101/217; 700/279

(57) ABSTRACT

An offset rotary printing machine which includes a first printing cylinder and a second printing cylinder in which printing is performed on a web at a nip between the pair of printing cylinders, the second printing cylinder contacting the first printing cylinder and being shifted downstream from the first printing cylinder. The printing machine includes an angle adjustment mechanism for adjusting an angle of a plane connecting center axes of the pair of printing cylinders which is inclined to a plane perpendicular to the moving direction of the web, and a controller for controlling the angle adjustment mechanism, based on parameters interrelating to a delamination occurrence probability that is caused as printing is performed by the downstream second printing cylinder.

### BACKGROUND OF THE INVENTION

(1) Field of the Invention

The present invention relates to an offset rotary printing machine and a method of adjusting angle of imaginary oblique plane, which is inclined with imaginary perpendicular plane being perpendicular to the moving direction of a web suitable for the prevention of web delamination.

(2) Description of the Related Art

An offset rotary printing machine, as shown in FIG. 13, supplies a roll of web (continuous paper) 10 from a web feeder section 1 by an in-feed device 2, and prints on the web 10 at a printing section 3, which comprises a suitable number of printing units 7. The printed web 10 goes through a dryer section 51, a cooling section 52, and a web pass section 53 and to a folding machine 6, in which the folded web is made. In the case of multicolor printing, the printing section 3 is provided with a number of printing units 7 that corresponds to the number of colors to be printed. Generally, offset rotary printing machines are able to print on both sides of the web at once.

FIG. 14 shows the configuration of a printing unit 7 installed in a perfecting press through which the web goes approximately horizontally. As shown in the figure, the printing unit 7 comprises an upper printing unit section 7a for printing on the obverse side of the web 10 and a lower printing unit section 7b for printing on the reverse side of the web 10.

The upper printing unit section 7a comprises a printing cylinder 8a around which a printing plate (not shown) with an image to be transferred is wrapped, an inker 18a for supplying ink to the printing cylinder 8a, a dampener 19a for transferring water to the printing cylinder 8a, and a blanket cylinder 9a for transferring the inked image from the printing plate to the obverse side of the web 10. The lower printing unit section 7b likewise comprises a printing cylinder 8b, an inker 18b, a dampener 19b, and a blanket cylinder 9b.

The upper and lower blanket cylinders 9a and 9b contact opposite each other at a predetermined printing pressure. The surfaces of the blanket cylinders 9a and 9b are covered with flexible blankets (not shown), and at the nip between these upper and lower blanket cylinders 9a and 9b, the upper and lower inked images are transferred to both sides of the web 10.

Note that the surface of each blanket cylinder has an axial groove formed therein, in which the longitudinally opposite ends of the blanket are fitted. With the opposite ends of the blanket fitted in the axial groove, the blanket is wrapped around the blanket cylinder surface.

Therefore, the blanket cylinder has a gap (groove) that does not contact with the web 10. Further, the upper and lower blanket cylinders 9a and 9b rotate in synchronization so that the respective gaps face each other at the nip therebetween. Therefore, when the gaps face each other at the nip, the printing pressure between the upper and lower blanket cylinders 9a and 9b changes and therefore tension (tensile stress) that is applied to the web 10 varies. As a result, the web 10 will be shifted in the conveying direction, whereby the printing position will also be shifted. In addition, the upper and lower blanket cylinders 9a and 9b vibrate, so that the web 10 moves up and down at the nip exist.

To suppress such a variation in tension that is applied to the web, in conventional offset rotary printing machines, by disposing the upper and lower blanket cylinders 9a and 9b so that a plane connecting the center axes of the upper and lower blanket cylinders 9a and 9b is inclined by a predetermined angle (hereinafter referred to as a staggered angle) α to a plane perpendicular to the web conveying direction, the web 10 is supported on the areas, other than the nip, of the surfaces of the upper and lower blanket cylinders 9a and 9b.

New developments in technology tend to reduce the length of the above-described gap, so the required staggered angle α also tends to decrease. Besides, the development of gapless blanket cylinders has made it possible to set the staggered angle relatively freely.

In such an offset rotary printing machine, as shown by a two-dot chain line in FIG. 15, the web 10 goes along the surface of the upper blanket cylinder 9a for a while on account of the adhesion of ink between the upper blanket cylinder 9a and the web 10, and then the web 10 is separated from the surface of the upper blanket cylinder 9a by tension applied to the web 10. As shown in FIGS. 16A and 16B, there are cases where the separation of the web 10 from the upper blanket cylinder 9a causes an indeterminate pattern (color density reduction) 16 called a delamination pattern (hereinafter referred to simply as delamination). If the delamination 16 occurs on a printed surface, this print is handled as waste paper.

To reduce the occurrence of the delamination, Japanese Unexamined Patent Application publication No. 2005-305752 discloses a technique for reducing delamination by setting the above-described staggered angle to a proper angle.

### SUMMARY OF THE INVENTION

The above-described delamination depends upon printing conditions, so an optimum staggered angle to effectively reduce delamination is considered to vary with printing conditions.

However, the technique in the aforementioned Japanese Unexamined Patent Application publication No. 2005-305752 considers printing conditions collectively, but does not vary the staggered angle according to respective printing conditions. As a result, there are cases where, depending on respective printing conditions, delamination can not reduced effectively.

The present invention has been made in view of the circumstances described above. Accordingly, it is an object of the present invention to provide an offset rotary printing machine and angle adjustment method that are capable of more reliably reducing the occurrence of delamination.

To achieve the object described above, there is provided an offset rotary printing machine which includes a first printing cylinder and a second printing cylinder in which printing is performed on a web at a nip (N) between the pair of printing cylinders, the second printing cylinder contacting the first printing cylinder and being shifted downstream from the first printing cylinder. The printing machine comprises an angle adjustment mechanism for adjusting an angle (α) of imaginary oblique plane, which is inclined with imaginary perpendicular plane being perpendicular to the moving direction of the web and is connecting between each center axis of the first printing cylinder and the second printing cylinder; and a controller for controlling the angle adjustment mechanism, based on parameters interrelating to a delamination occurrence probability (φ) that is caused as printing is performed by the second printing cylinder.

It is preferred that the aforementioned controller comprises corresponding-relationship setting parts for setting a corresponding-relationship setting part for setting a corresponding relationship between the delamination occurrence probability (φ) and the angle (α), based on printing-related information equivalent to the parameters which includes information on images to be printed, information on ink used, information on property of the web, and information on a support span of the web located downstream of the second printing cylinder; optimum-range calculator for calculating an optimum range for the angle (α) which causes the delamination occurrence probability (φ) to be a preset probability or less, based on the corresponding relationship that was set by the corresponding-relationship setting part; and command part for outputting a command signal to the angle adjustment mechanism to cause the angle (α) to be within the optimum range calculated by the optimum-range calculator.

According to the controller described above, the corresponding relationship between the delamination occurrence probability and the angle is obtained based on concrete printing-related information. As a result, an optimum range for the angle can be calculated. Accordingly, if the angle is set to the optimum range, the occurrence of delamination can be more reliably prevented.

It is preferred that the aforementioned image information includes a second printing area ratio (M2) of a second image that is transferred by the second printing cylinder, and a first printing area ratio (M1) of a first image that is transferred by the first printing cylinder; the ink information includes information on ink tack (t); the web-property information includes information on rigidity (G) of the web; the support span information includes information on an inter-color length (L*) which is a distance between the nip (N) of the pair of printing cylinders and a next nip of a next pair of printing cylinders adjacent to the pair of printing cylinders; and the corresponding-relationship setting part sets, as an amount interrelating to the printing-related information, a tension variation amount (Tn) in a paper plane which indicates a variation in tension in a width direction of the web on a downstream side of the nip (N) of the pair of printing cylinders, and also sets the corresponding relationship so that the tension variation amount (Tn) satisfies

φ=c·exp(Tn)

where φ represents the delamination occurrence probability, c represent a constant, and Tn represents the tension variation amount.

Accordingly, by directing attention to the tension variation amount, an optimum range for the angle can be calculated. By setting the angle to the optimum range, the occurrence of delamination can be more reliably prevented.

It is preferred that tension variation amount (Tn) is a function of a web separating angle (θ) which is an angle interrelating to the second printing area ratio (M2) of the second image, the ink tack (t), and the angle (α) and which is an angle of the web to a surface of the second printing cylinder formed as the web is separated from the surface; the rigidity (G) of the web; the printing area ratio (M2) of the second image; and a contact amount (β) of the web to a surface of the first printing cylinder which is an amount corresponding to the angle (α).

It is preferred that the aforementioned controller controls the angle adjustment mechanism under particular conditions in which delamination can occur.

In this case, when no delamination occurs, it is not necessary to perform wasteful operation.

It is preferred that the aforementioned particular conditions are that the first and second images are transferred to both sides of the web; a difference between the first printing-area ratio and the second printing area ratio is a preset threshold value or greater; the second image to be transferred by the second printing cylinder contains a nonprinting area; and a portion of the first image which corresponds to the nonprinting area of the first image has a printing area ratio which is a preset value or greater.

It is preferred that the aforementioned particular conditions are that both an average of the first printing area ratio of the first image and an average of the second printing area ratio of the second image are a first reference value or greater.

It is preferred that the aforementioned particular conditions are that the second printing area ratio of the second image is a second reference value or greater, and a printing area ratio of a portion of the first image is a third reference value or greater.

In these cases, conditions in which delamination can occur can be decided.

It is preferred that the offset rotary printing machine further comprises noise sensor for sensing, as a parameter interrelating to the delamination occurrence probability (φ), a noise level that is generated as printing is performed by the pair of printing cylinders;

wherein, based on the noise level sensed by noise sensor, the controller controls the angle adjustment mechanism to adjust the angle (α) so that the noise level is reduced.

In this case, the angle (α) is adjusted based on the noise level which is a parameter interrelating to the delamination occurrence probability, whereby the occurrence of delamination can be reliably suppressed.

It is preferred that the aforementioned controller adjusts the angle (α) based on the noise level at an adjustment stage before printing is performed by the pair of printing cylinders.

In this case, the angle (α) is adjusted before printing is performed. Even if the angle (α) is made constant during printing, there is no problem because printing conditions are not changed.

In accordance with the present invention, A method of adjusting an angle (α) of imaginary oblique plane, which is inclined with imaginary perpendicular plane being perpendicular to the moving direction of a web and is connecting between each center axis of an first printing cylinder and an second printing cylinder, the pair of printing cylinders being equipped with an offset rotary printing machine printing on the web at a nip (N) between the pair of printing cylinders, the second printing cylinder contacting the first printing cylinder and being shifted downstream from the first printing cylinder. The method comprises an information acquisition step of acquiring, as parameters interrelating to a delamination occurrence probability (φ) that is caused as printing is performed by the second printing cylinder, printing-related information which includes information on images to be printed, information on ink used, information on property of the web, and information on a support span of the web located downstream of the second printing cylinder; a corresponding-relationship setting step of setting a corresponding relationship between the delamination occurrence probability (φ) and the angle (α), based on the information acquired by the information acquisition step; and an angle setting step of setting the angle (α) to a range which causes the delamination occurrence probability (φ) to be a preset probability or less, based on the corresponding relationship that was set by the corresponding-relationship setting step.

It is preferred that the aforementioned image information includes a second printing area ratio (M2) of a second image that is transferred by the second printing cylinder, and a first printing area ratio (M1) of a first image that is transferred by the first printing cylinder; the ink information includes information on ink tack (t); the web-property information includes information on rigidity (G) of the web; the support span information includes information on an inter-color length (L*) which is a distance between the nip (N) of the first pair of printing cylinders and a next nip of a next pair of printing cylinders adjacent to the first pair; and the corresponding-relationship setting step sets, as an amount interrelating to the printing-related information, a tension variation amount (Tn) in a paper plane which indicates a variation in tension in a width direction of the web on a downstream side of the nip (N) of the pair of printing cylinders, and also sets the corresponding relationship so that the tension variation amount (Tn) satisfies

φ=c·exp(Tn)

where φ represents the delamination occurrence probability, c represent a constant, and Tn represents the tension variation amount.

It is preferred that the tension variation amount (Tn) is a function of a web separating angle (θ) which is an angle interrelating to the second printing area ratio (M2) of the second image, the ink tack (t), and the angle (α) and which is an angle of the web to a surface of the second printing cylinder formed as the web is separated from the surface; the rigidity (G) of the web; the printing area ratio (M2) of the second image; and a contact amount (β) of the web to a surface of the first printing cylinder which is an amount corresponding to the angle (α).

It is preferred that the method further comprises a property selection step of selecting at least either the property of the web or the kind of ink used, based on a corresponding relationship between at least either the property of the web or the kind of ink used and the delamination occurrence probability, prior to the information acquisition step.

In accordance with the present invention, in a method of adjusting an angle (α) of imaginary oblique plane, which is inclined with imaginary perpendicular plane being perpendicular to the moving direction of a web and is connecting between each center axis of an first printing cylinder and an second printing cylinder, the pair of printing cylinders being equipped with an offset rotary printing machine printing on the web at a nip (N) between the pair of printing cylinders, the second printing cylinder contacting the first printing cylinder and being shifted downstream from the first printing cylinder. The method comprises a noise sensing step for sensing, as a parameter interrelating to a delamination occurrence probability (φ) that is caused as printing is performed by the second printing cylinder, a noise level that is generated as printing is performed by the pair of printing cylinders; and an angle adjustment step which, based on the noise level sensed by noise sensing step, adjusts the angle (α) so that the noise level is reduced.

It is preferred that the aforementioned angle adjustment step is carried out at an adjustment stage before printing is performed by the pair of printing cylinders.

Therefore, according to the offset rotary printing machine and the method of adjusting the angle of the present invention, the angle (staggered angle) (α) is adjusted based on parameters interrelating to the probability of lamination occurrence, whereby the occurrence of delamination can be more reliably suppressed.

### BRIEF DESCRIPTION OF THE DRAWINGS

The present invention will be described in further detail with reference to the accompanying drawings wherein:

FIG. 1 is a plan view used to explain the mechanism of delamination occurrence, and showing an image that is transferred from an upper blanket cylinder to a web;

FIGS. 2A to 2D are schematic diagrams used to explain the mechanism of delamination occurrence, and showing how the web passes between upper and lower blanket cylinders;

FIG. 3 is a schematic side view used to explain the mechanism of delamination occurrence and an offset rotary printing machine of a first embodiment of the present invention, and showing the adhesive force and tension that are applied to the web;

FIG. 4 is a diagram used to explain the mechanism of delamination occurrence, and showing temporal changes in tension applied to the nonprinting area and printing area of the web as it goes between the upper and lower blanket cylinders;

FIG. 5 is a schematic side view used to explain the mechanism of delamination occurrence, and showing tension variations that occur in the web because of its gap;

FIG. 6 is a schematic side view used to explain an offset rotary printing machine according to a first embodiment of the present invention, and showing a pair of printing cylinders;

FIG. 7 is a functional block diagram used to explain the offset rotary printing machine according to the first embodiment of the present invention, and showing the functions of a controller;

FIGS. 8A to 8K are graphs used to explain the offset rotary printing machine and according to the first embodiment of the present invention, and showing the corresponding relationship between printing-related information and a variation in tension;

FIG. 9 is a graph used to explain the offset rotary printing machine according to the first embodiment of the present invention, and showing the corresponding relationship between the tension variation and the probability of delamination occurrence;

FIG. 10 is a schematic diagram used to explain the offset rotary printing machine according to the first embodiment of the present invention, and showing an example of an angle adjustment mechanism;

FIGS. 11A and 11B are schematic diagrams used to explain the offset rotary printing machine according to the first embodiment of the present invention, and showing different examples of the angle adjustment mechanism;

FIG. 12 is a block diagram used to explain an offset rotary printing machine according to a second embodiment of the present invention, and showing a simplified configuration of a control system;

FIG. 13 is a side view used to explain the offset rotary printing machine according to the first embodiment of the present invention, and showing a simplified configuration of the offset rotary printing machine;

FIG. 14 is a schematic diagram used to explain the offset rotary printing machine according to the first embodiment of the present invention, and showing the configuration of the printing unit;

FIG. 15 is a schematic side view used to explain a conventional offset rotary printing machine, and showing a pair of printing cylinders;

FIG. 16A illustrates an example of delamination caused by printing, an image transferred to a web of paper being shown;

FIG. 16B illustrates another example of delamination caused by printing, another image transferred to the web being shown;

FIGS. 17A and 17B are diagrams used to explain the mechanism of delamination occurrence, and schematically showing tension wrinkles caused by a variation in tension; and

FIGS. 18A to 18D are graphs used to explain the offset rotary printing machine and angle adjustment method according to the first embodiment of the present invention, and showing the corresponding relationship between printing-related information and the tension variation.

### DETAILED DESCRIPTION OF THE PREFERRED EMBODIMENTS

### (Mechanism of Delamination Occurrence)

Before describing embodiments of the present invention, a description will be given of the mechanism of delamination occurrence that the present inventors have understood. Note that the same parts as those employed in the description of the related art will be described, using the same reference numerals.

First, a description will be given of the mechanism of delamination occurrence in the case where an image on the obverse side of a web of paper (which is transferred by an upper blanket cylinder) includes a nonprinting area or an area with a low printing area ratio equivalent to the nonprinting area.

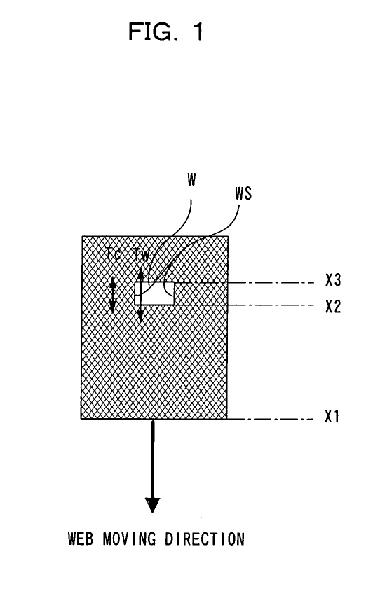

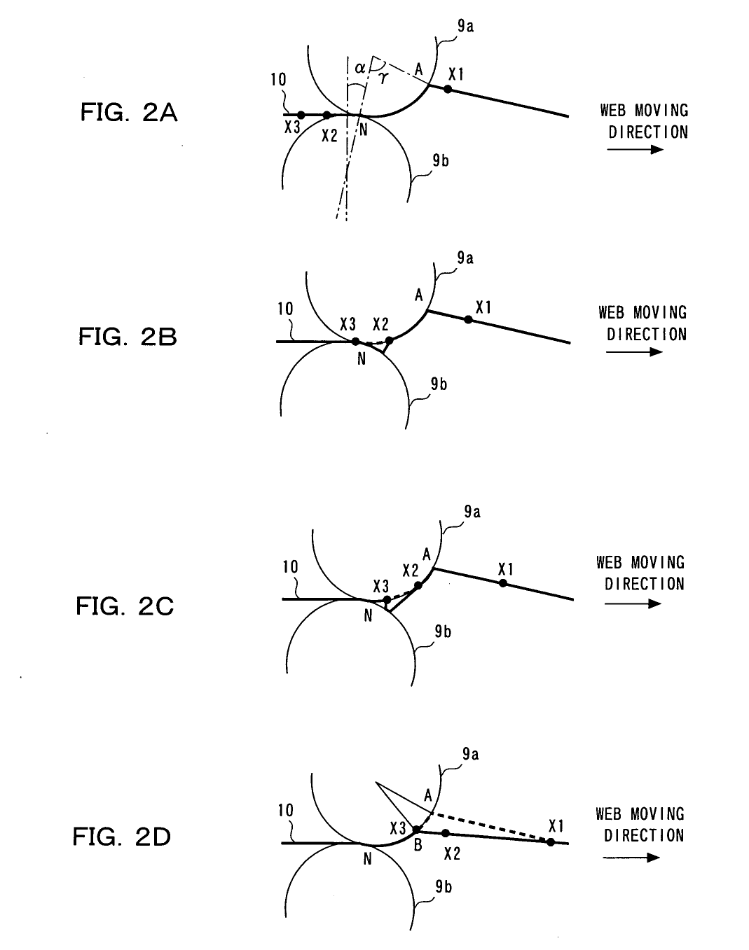

FIG. 1 shows an obverse-side image that is transferred from an upper blanket cylinder 9a to the obverse side of a web of paper 10, and FIGS. 2A to 2D are schematic diagrams showing how the web 10 passes between upper and lower blanket cylinders 9a and 9b. In this embodiment, the upper blanket cylinder (second printing cylinder) 9a is arranged downstream, while the lower blanket cylinder (first printing cylinder) 9b is arranged upstream. The configuration of the blanket cylinders 9a and 9b is not limited to this example.

As shown in FIG. 1, the obverse-side image includes a nonprinting area (or an area with a low printing area ratio) W. Although not shown, a reverse-side image that is transferred from the lower blanket cylinder 9b to the reverse side of the web 10 has a printing area ratio equal to or greater than a predetermined threshold value over its entire surface that includes an area corresponding to the nonprinting area of the obverse-side image.

As shown in FIG. 2A, the upper and lower blanket cylinders 9a and 9b contact in opposition to each other at a predetermined printing pressure, and at the nip between these blanket cylinders 9a and 9b, the inked images are transferred to both sides of the web 10. The upper and lower blanket cylinders 9a and 9b are disposed at a staggered angle α so that the upper blanket cylinder 9a is positioned downstream with respect to the web moving direction and the lower blanket cylinder 9b is positioned upstream.

A description will hereinafter be given of how the web 10 and upper and lower blanket cylinders 9a and 9b operate as the web 10 to which the obverse-side image shown in FIG. 1 is transferred passes through the nip.

First, as in interval X1 to X2 of FIG. 1, in the case where both sides of the web 10 are printed at high printing area ratios greater than a predetermined level, as shown in FIG. 2A, after passing through the nip N, the web 10 is separated from the lower blanket cylinder 9b and brought into contact with the upper blanket cylinder 9a.

This is considered to be for the following reasons. Since the upper blanket cylinder 9a is shifted downstream with respect to the web moving direction than the lower blanket cylinder 9b, the upper blanket cylinder 9a becomes closer to the orbit of the web 10 after the web 10 passes through the nip N. As a result, the web 10 is brought into contact with the upper blanket cylinder 9a by the adhesive force of the inked image of the upper blanket cylinder 9a. Therefore, conversely, when the setting of the staggered angle α is changed so that the lower blanket cylinder 9b is shifted downstream of the upper blanket cylinder 9a, the web 10 is first separated from the upper blanket cylinder 9a.

After the web 10 has been separated from the lower blanket cylinder 9b, because of the adhesive force (which is applied in the radial direction of the upper blanket cylinder 9a) between the upper blanket cylinder 9a and the web 10 resulting from the inked image of the upper blanket cylinder 9a, the web 10 goes along the surface of the upper blanket cylinder 9a to a separating position A without being separated from the upper blanket cylinder 9a and is separated from the upper blanket cylinder 9a at the separating position A. Note that the angle of rotation of the upper blanket cylinder 9a from the nip N to the separating position A will hereinafter be referred to as a contact angle γ.

When the nonprinting area W indicated by the interval X2 to X3 of FIG. 1 passes through the nip N, as shown by a solid line in FIG. 2B, the adhesive force of ink to be transferred from the upper blanket cylinder 9a is small at that portion in the width direction of the web 10 which corresponds to the nonprinting area W, and consequently, the web 10 is not separated from the lower blanket cylinder 9b by the adhesive force of ink that is transferred from the lower blanket cylinder 9b. Thus, conversely, the web 10 is first separated from the upper blanket cylinder 9a.

On the other hand, the printing areas on the opposite sides in the width direction of the nonprinting area W, as shown by a dashed line in FIG. 2B, are first separated from the lower blanket cylinder 9b in the same manner shown in FIG. 2A and then separated from the upper blanket cylinder 9a at the separating position A.

Thereafter, if the web 10 further goes forward, as shown in FIG. 2C, the nonprinting area W begins to separate from the lower blanket cylinder 9b. On the other hand, the printing areas on the opposite sides in the width direction of the nonprinting area W separate from the upper blanket cylinder 9a at the separating position A, as in the case of FIG. 2C.

When the nonprinting area W is completely separated from the lower blanket cylinder 9b, as shown in FIG. 2D, in the interval X2 to X3 of FIG. 1 the web 10 has already been separated from upper blanket cylinder 9a and therefore the separating position between the web 10 and the upper blanket cylinder 9a moves from the separating position A to another separating position B. Note that the separating position A of the printing area does not change.

Thus, when the obverse-side image contains the nonprinting area W and the portion of the reverse side image which corresponds to the nonprinting area W has a printing area ratio greater than a predetermined level, the separating position of the web 10 from the upper blanket cylinder 9a which corresponds to the nonprinting area W moves from position A to position B.

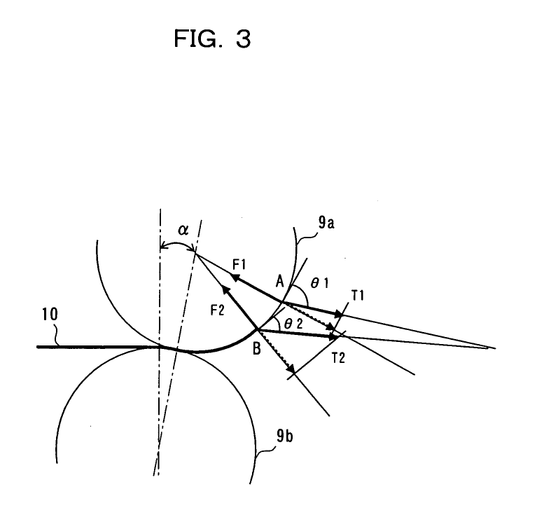

FIG. 3 shows the tension applied to the web 10 in the moving direction at the separating position A of FIG. 2A and separating position B of FIG. 2D, and the adhesive force applied to the web 10 by the upper blanket cylinder 9a.

As shown in FIG. 3, at the separating position A, adhesive force F1 is applied to the web 10 in the radial direction of the upper blanket cylinder 9a by the inked image of the upper blanket cylinder 9a.

Because the web 10 is separated from the upper blanket cylinder 9a at the separating position A, a separating force which is the same in magnitude as the adhesive force F1 is applied to the web 10 in the opposite direction at the separating position A, as shown by a dashed line in FIG. 3. This separating force is created by tension T1 applied to the web 10. More specifically, if the separating direction of the web 10 with respect to the tangential direction of the upper blanket cylinder 9a at the separating position A is represented by an angle θ1, then the separating force at the separating position A can be expressed as T1·sin θ1.

At the separating position B, adhesive force F2 is applied to the web 10 in the radial direction of the upper blanket cylinder 9a. Since the web 10 is separated from the upper blanket cylinder 9a at the separating position B, a separating force which is the same in magnitude as the adhesive force F2 is applied to the web 10 in the opposite direction at the separating position B, as shown by a dashed line in FIG. 3. This separating force can be expressed as T2·sin θ2, using the separating angle θ2 of the web 10 at the separating position B and tension T2 applied to the web 10.

Now, consider the adhesive force F1 applied at the separating position A and the adhesive force F2 applied at the separating position B. The adhesive forces F1 and F2 result mainly from the viscosity of ink, so they are determined by an ink tack value t and a printing area ratio (i.e., an ink amount) of an obverse-side image that is printed. That is, if the kind of ink to be used is selected, when the printing area ratios at positions A and B are the same, or a difference between them is considered practically negligible, the magnitudes of the adhesive forces F1 and F2 can be the to be approximately the same.

If the adhesive forces F1 and F2 are approximately the same in magnitude, then the separating positions A and B and separating angles θ1 and θ2 are determined by the magnitudes of tension T1 and tension T2.

For example, if the tension applied to the web 10 becomes smaller, the separating angle becomes larger (or becomes close to 90°). On the other hand, the tension applied to the web 10 becomes larger, the separating angle becomes smaller (or becomes close to 0°).

A variation in the tension applied to the web 10 is also caused by a variation in the separating position (i.e., a variation in the contact angle γ). As described with reference to FIGS. 2A to 2D, in the case where the separating position of the web 10 moves, for example, from the position A to the position B, the tension applied to the web 10 varies with the movement of the separating position.

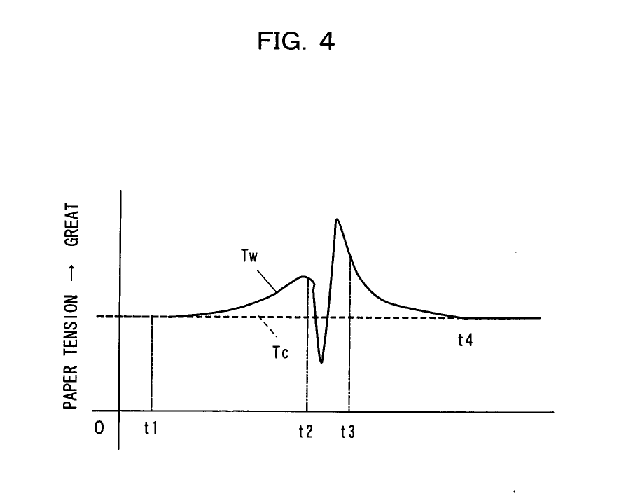

FIG. 4 shows temporal changes in the tension applied to the web 10 shown in FIGS. 2A to 2D. Note in FIG. 4 that tension Tw applied to the nonprinting area W is indicated by a solid line, while tension Tc applied to the printing areas on both sides in the width direction of the nonprinting area W is indicated by a dashed line.

As shown in FIG. 4, in the state of FIG. 2A (interval 0 to t1 in FIG. 4), tension applied to the nonprinting area of the web 10 is approximately the same as that applied to the printing area of the web 10.

In the states of FIGS. 2B and 2C (interval t1 to t2 in FIG. 4), the nonprinting area W adheres to the lower blanket cylinder 9b, and the printing area positioned upstream of the nonprinting area W adheres to the upper blanket cylinder 9a until the separating position A, so the tension applied to the nonprinting area W increases gradually.

Next, in the state of FIG. 2D (interval t2 to t3 in FIG. 4), the nonprinting area W is completely separated from the lower blanket cylinder 9b at the separating position A, so the tension Tw applied to the web 10 is suddenly reduced in a moment. At this stage, the separating position of the web 10 is moved from position A to position B.

When the observe-side printing area following after the nonprinting area W reaches the separating position B, the adhesive force F2 between the web 10 and the upper blanket cylinder 9a is suddenly applied and therefore the tension Tw applied to the web 10 increases suddenly.

Thereafter (interval after t3), the separating position of the web 10 returns to the position A and becomes stable, so that the tension Tw applied to the nonprinting area W becomes approximately equal to the tension Tc.

Thus, a sudden change in the tension Tw applied to the web 10 causes a difference between the tension Tw of the nonprinting area W and the tension Tc of the printing area, so that the tension applied to the web 10 varies in the width direction of the web 10. This variation will hereinafter be referred to as tension variation Tn.

If the tension variation Tn occurs, wrinkles will occur at the boundary WS (see FIG. 1) in the web moving direction between the nonprinting area W and the printing area. These wrinkles will hereinafter be referred to as separation wrinkles or tension wrinkles. The separation wrinkles are considered to cause a variable density boundary (i.e., delamination) to occur in a printed image.

Now, a description will be given of the mechanism of delamination occurrence in the case where obverse-side and reverse-side images with a uniform high printing area ratio (e.g., 80%) are transferred to both sides of the web 10.

Although described in detail later, even in the case where images with a high printing area ratio are respectively transferred to both sides of the web 10, as with the above case where the obverse-side image contains a nonprinting area, a variation in the tension applied to the web 10 likewise causes the occurrence of delamination.

However, the case where images with a high printing area ratio are transferred to both sides of the web 10 differs from the above case in that the main cause of the tension variation is not a variation in the separating position but the gap formed in the circumference of the upper blanket cylinder 9a.

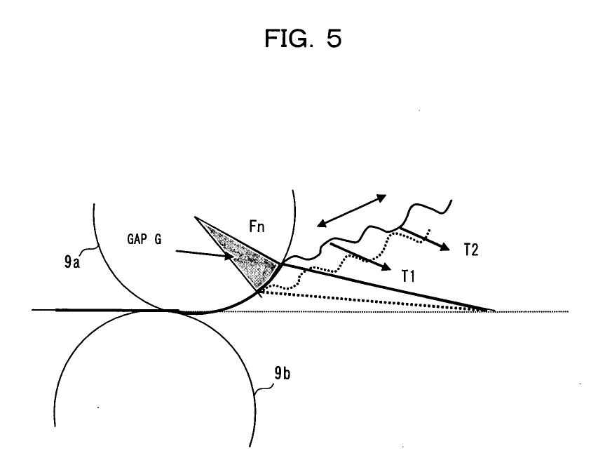

As shown in FIG. 5, in the case where a gap G is formed in the circumference of the upper blanket cylinder 9a, the inked image is not transferred to the web 10 at the gap G and therefore there is no adhesive force between the web 10 and the upper blanket cylinder 9a in the vicinity of the gap G.

Since the printing area ratios of the obverse-side and reverse-side images are the same, the web 10 appears to have no tension variation at one view, but tension wrinkles have occurred due to the balance of rigidity and expansion/contraction of the web 10.

The tension wrinkles can occur at arbitrary positions in the width direction (perpendicular to the web moving direction) of the web 10.

The cause of the occurrence of the tension wrinkles is as follows. When the gap in the circumference of the upper blanket cylinder 9a is passing the web separating position, no adhesive force is applied to the web 10 at the gap, and after passing the gap, an adhesive force is again applied to the web 10.

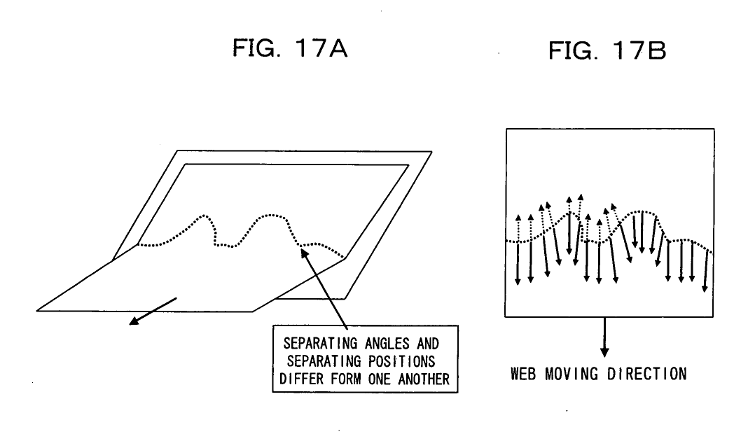

Because of this, the tension applied to the web 10 varies in the width direction of the web 10, and the contact angles γ (i.e., web separating positions) of the web 10 with respect to the upper blanket cylinder 9a become non-uniform, as shown by a dashed line in FIG. 17A. As shown in FIG. 17B, tension (see arrows) varies greatly with the web separating positions, so that tension wrinkles are created. Note that the total tension in the width direction of the web 10 does not change.

That is, the separating position and direction of the web 10 from the upper blanket cylinder 9a is determined by the balance of the adhesive force of the web and the tension applied to the web. Since the balances differ from one another in the web width direction, the web separating positions and angles differ from one another, as shown in FIG. 17A. Such a variation (difference) in the tension balance in the web width direction causes the propagation of tension balance, whereby tension wrinkles are created. This can cause delamination that is widen toward the end, or delamination that occurs on the way.

### (Summary of the Mechanism of Delamination Occurrence)

While the mechanism of delamination occurrence has been described in two cases, in either case a sudden variation in the tension applied to the web 10 increases the tension variation Tn, thereby resulting in the occurrence of delamination. Therefore, the greater the tension variation Tn of the web, the greater the delamination occurrence probability φ.

For conditions concerning the tension variation Tn, the inventors have found the following facts:

(1) The larger the staggered angle, the larger the contact angle γ.

(2) The larger the contact angle γ, the greater the tension variation Tn.

(3) The greater the paper rigidity G, the smaller the tension variation Tn. Note that the paper rigidity G is a value representing the difficulty of deforming paper.

(4) Adhesive force F is proportional to tension Tn.

(5) The larger the paper elongation amount L, the greater the tension variation Tn. More particularly, in the case where the paper elongation amount L is large, the rigidity in the width direction of the web 10 becomes small and therefore the tension variation Tn in the web width direction becomes great.

(6) The shorter the inter-color length, the smaller the tension variation Tn. To reduce the delamination occurrence probability φ, it is necessary to make the tension variation Tn as small as possible.

To reduce the tension variation Tn, it is considered necessary to set the staggered angle α properly. If the staggered angle α is made smaller, the contact angle γ becomes smaller (i.e., the paper separating position is moved downward). This reduces the tension variation Tn and effectively reduces delamination.

However, since the tension variation Tn depends upon adhesive force F, paper rigidity G, paper elongation amount L, etc., a reduction in the staggered angle α alone cannot reduce the tension variation Tn effectively.

For instance, in the case where the staggered angle α is made 0 degrees (vertical), the behavior of the web 10 becomes unstable as it is separated from the upper and lower blanket cylinders 9a and 9b. As a result, at the nip between the upper and lower blanket cylinders 9a and 9b, the image transferring position is shifted and therefore double transferring of an image is performed. Thus, there is a strong possibility that printing faults other than delamination will occur.

Also, in the case where an image to be transferred from the upper blanket cylinder 9a is an extremely small image (or an image whose printing area ratio is small) while an image to be transferred from the lower blanket cylinder 9b is an extremely large image (or an image whose printing area ratio is high), the adhesive force between the obverse side of the web 10 and the upper blanket cylinder 9a differs from the adhesive force between the reverse side of the web 10 and the lower blanket cylinder 9b, and consequently, a proper staggered angle α varies.

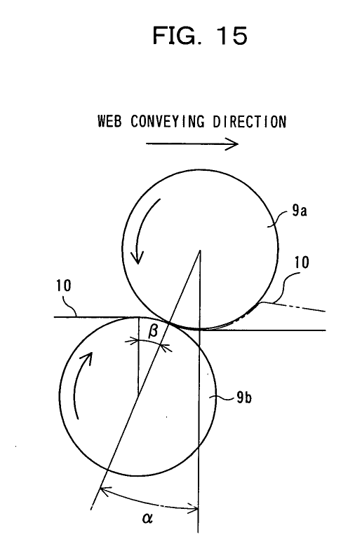

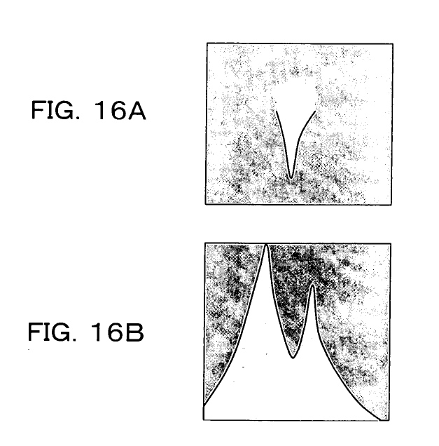

Furthermore, changing the contact amount β (see FIG. 15) by the setting of the staggered angle α has a great influence on the probability of delamination occurrence.

More specifically, the tension variation Tn varies even by the kind of ink used, paper kind of web 10, respective printing area ratios of inked images to be transferred from the upper and lower blanket cylinders 9a and 9b (which correspond to the amounts of ink to be transferred), positions of images disposed, and contact amount β, so it is necessary to set a proper staggered angle α, taking these conditions into account.

### First Embodiment

An embodiment of the present invention will hereinafter be described with reference to the drawings. The drawings used in the description of the related art are also employed in described the present invention.

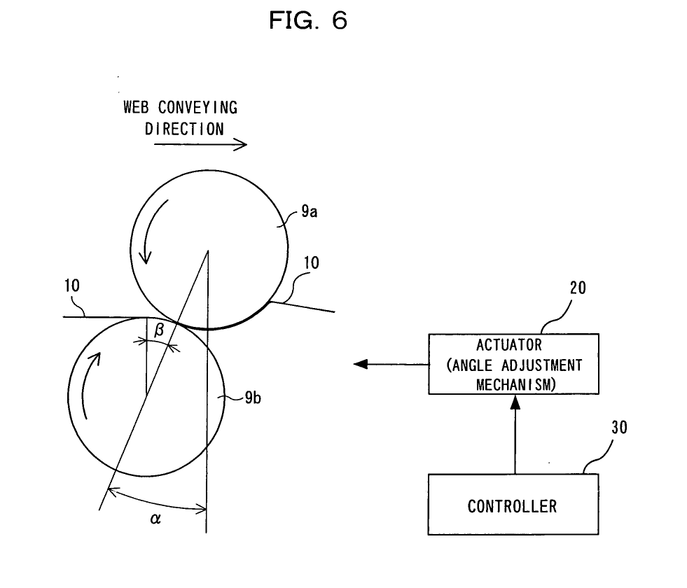

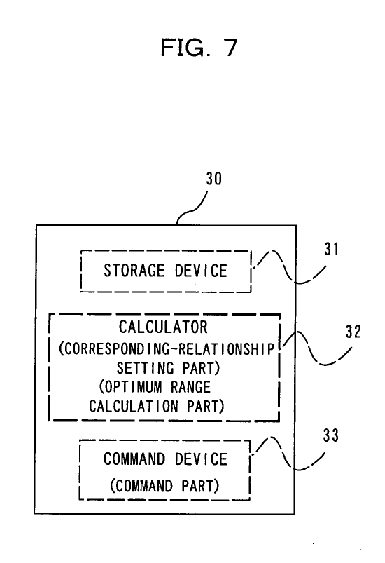

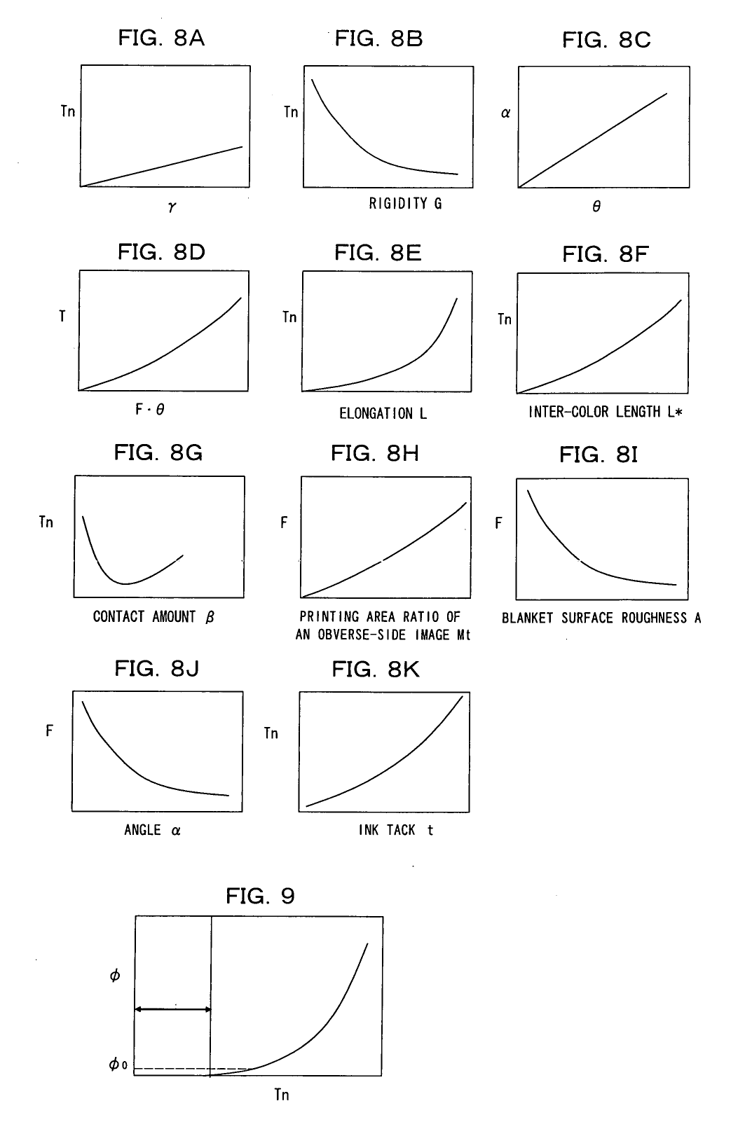

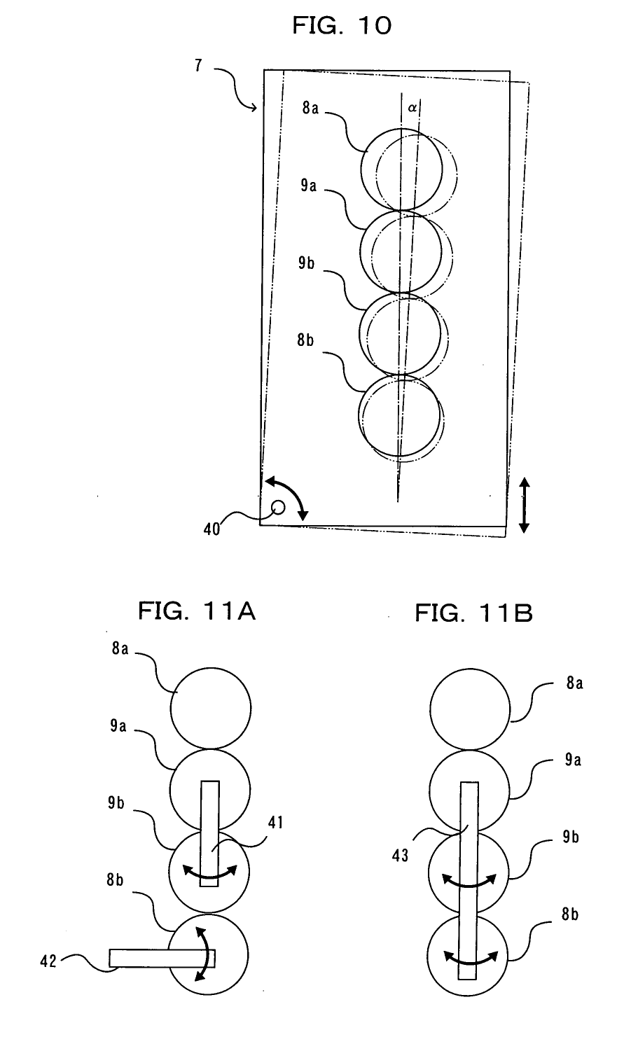

FIGS. 6, 7, 8A to 8K, 9, 10, 11A and 11B are used for explaining an offset rotary printing machine of a first embodiment of the present invention. FIG. 6 is a schematic side view showing a pair of printing cylinders, FIG. 7 is a functional block diagram showing the functions of a controller, and FIGS. 8A to 8K each illustrate the corresponding relationship between printing-related information and a variation in tension. FIG. 9 is a graph showing the corresponding relationship between the tension variation and the probability of delamination occurrence, FIG. 10 a schematic diagram showing an example of an angle adjustment mechanism, and FIGS. 11A and 11B schematic diagrams showing different examples of the angle adjustment mechanism. In the present embodiment, the present invention is applied to the same printing machine as that employed in the description of the related art.

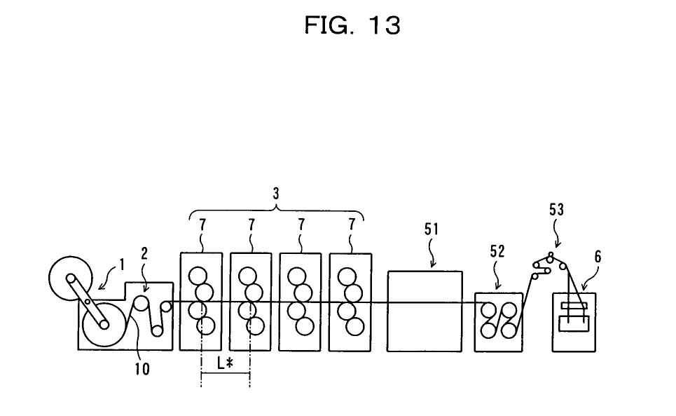

As shown in FIG. 13, the offset rotary printing machine of the present invention includes a web feeder section 1, an in-feed device 2, a printing section 3, a dryer section 51, a cooling section 52, a web pass section 53, and a folding machine 6. A roll of web (continuous paper) 10 attached to the web feeder section 1 is supplied by the in-feed device 2 and is printed in the printing section 3.

The printing section 3 comprises four printing units 7 that respectively correspond to ink colors of C (cyan), M (magenta), Y (yellow), and K (black). It is noted that the number of printing units 7 may be one. The printing units 7 are installed according to the number of colors that are printed.

The web 10 printed in the printing section 3 goes through the dryer section 51, cooling section 52, and web pass section 53 and is conveyed to the folding machine 6, in which the folded web 10 is made.

### (Configuration of the Printing Unit)

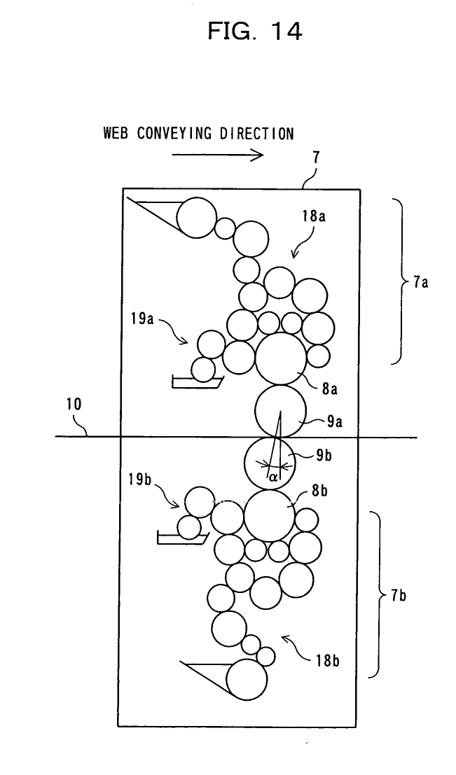

As shown in FIG. 14, the printing unit 7 comprises an upper printing unit 7a for printing on the obverse side of the web 10 and a lower printing unit 7b for printing on the reverse side of the web 10.

The upper printing unit 7a comprises a printing cylinder 8a around which a printing plate (not shown) with an image to be printed is wrapped, an inker 18a for supplying ink to the printing cylinder 8a, a dampener 19a for transferring water to the printing cylinder 8a, and a blanket cylinder 9a for transferring the inked image from the printing plate to the obverse side of the web 10. The lower printing unit 7b similarly comprises a printing cylinder 8b, an inker 18b, a dampener 19b, and a blanket cylinder 9b.

As shown in FIG. 6, in each of the printing units 7, the downstream blanket cylinder (second printing cylinder) 9a and upstream blanket cylinder (first printing cylinder) 9b contact in opposition to each other at a predetermined printing pressure. In other words, second printing cylinder 9a is in contact to the first printing cylinder 9b and is shifted downstream from first printing cylinder 9b. At the nip between these blanket cylinders 9a and 9b, inked images are transferred to both sides of the web 10, respectively.

In the present embodiment, the downstream blanket cylinder 9a, arranged above the web 10 for transferring the inked image to the obverse side of the web 10, is called an upper blanket cylinder, while the upstream blanket cylinder 9b, arranged under the web 10 for transferring the inked image to the obverse side of the web 10, is called a lower blanket cylinder. The configuration of the blanket cylinders 9a and 9b is not limited to this example.

Note that the surface of each of the blanket cylinders 9a and 9b has an axial groove formed therein, in which the longitudinally opposite ends of the blanket are fitted. With the opposite ends of the blanket fitted in the axial groove, the blanket is wrapped around the blanket cylinder surface.

Therefore, the blanket cylinder has a gap (groove) that does contact with the web 10. Further, the upper and lower blanket cylinders 9a and 9b rotate in synchronization so that the respective gaps face each other at the nip therebetween.

The upper and lower blanket cylinders 9a and 9b are further disposed so that an imaginary oblique plane connecting the center axes of the upper and lower blanket cylinders 9a and 9b is inclined by a predetermined angle (hereinafter referred to as a staggered angle) α to an imaginary perpendicular plane to the web conveying direction. Stated another way, the upper blanket cylinder 9a is shifted downstream in the rotation direction of the lower blanket cylinder 9b (downstream in the web conveying direction) from the position right above the lower blanket cylinder 9b by the staggered angle α, or the lower blanket cylinder 9b is shifted upstream in the rotation direction of the upper blanket cylinder 9a (downstream in the web conveying direction) from the position right under the upper blanket cylinder 9a by the staggered angle α.

The staggered angle α can be adjusted by an actuator 20, which is in turn controlled by a controller 30. The detailed configuration of the actuator 20 will be described later.

### (Functional Construction of the Controller)

The functional construction of the controller 30 will be described with reference to FIG. 7. As shown in the figure, the controller 30 is constructed by a computer from a storage device 31, a calculator (corresponding-relationship setting part and optimum-range calculator) 32, and a command device 33.

The storage device 31 stores printing-related information of various kinds (which are to be described later) as parameter information interrelated with the probability of delamination occurrence which is caused by the transfer of the inked image from the upper blanket cylinder 9a.

The calculator 32 sets the corresponding relationship between the probability of delamination occurrence and the above-described staggered angle on the basis of printing-related information, and calculates an optimum range for the staggered angle that causes the probability of delamination occurrence to be a predetermined probability or less, on the basis of the corresponding relationship. The command device 34 transmits a drive signal for driving the actuator 20 so that the staggered angle α becomes equal to an angle of inclination calculated by the calculator 33.

### (Printing-Related Information)

The storage device 31 stores image information, ink information, and material information web property information and supports span information of the web 10, as printing-related information.

These pieces of printing-related information may be input to the storage device 31 beforehand (information acquisition step). Prior to this, at least either the web property of the web or the kind of ink to be used is selected beforehand on the basis of the corresponding relationship with the probability φ of delamination occurrence that will be described later (property selection step).

As image information, the printing area ratio data Mt of an obverse-side image (printing area ratio M2 of a second image) that is transferred from the upper blanket cylinder 9a to the obverse side of the web 10, and the printing area ratio data Mb of a reverse-side image (printing area ratio M1 of a first image) that is transferred from the upper blanket cylinder 9a to the reverse side of the web 10, are input and stored.

As ink information, ink tack information t is input and stored for ink of each color that is used. The ink tack information t represents a value relating to the adhesive force (viscosity) of ink.

As the property information of the web 10, information of rigidity G and paper elongation amount L of the web 10 is stored. The paper elongation amount L is related to the rigidity G and is the amount of deformation of the web 10 by the tension applied to the web 10, but the paper elongation amount L can be calculated according to the paper quality (paper kind) of the web 10 and the tension applied to the web 10. Therefore, the paper elongation amount L that corresponds to paper kind and tension can be calculated beforehand by experiment, etc.

As support span information, the information of the distance (inter-color length) L* of the two nips between two printing units 7 is stored. The storage device 31 also stores the current staggered angle α.

The storage device 31 further stores the contact amount β as related information of the support span information.

As shown in FIG. 6, the contact amount β is expressed as the length that the web 10 contacts the lower blanket cylinder 9b until the nip between the upper and lower blanket cylinders 9a and 9b, but it may be expressed as the angle of rotation of the lower blanket cylinder 9b.

Note that the contact amount β can be calculated from the relationship between the horizontal travel position of the web 10 (travel position of the web 10 in the state before the web 10 contacts the lower blanket cylinder 9b) and the staggered angle α.

The storage device 31 further stores the information of the contact angle γ. The contact angle γ can be calculated according to the paper quality of the web 10, the kind of ink, and the printing area ratio of an image beforehand by experiment, etc.

The storage device 31 further stores the surface roughness A of the upper blanket cylinder 9a as printing-related information.

The storage device 31 further stores maps (functions), shown in FIGS. 8A to 8K, which each represent the corresponding relationship between each information described above and an amount interrelating to the information. Particularly, employing these maps, the tension variation Tn is set as an amount interrelating to the printing-related information of various kinds described above.

Note that these map data are calculated beforehand by experiment on the basis of the mechanism of delamination occurrence described above.

Now, these map data will be described. FIG. 8A illustrates the corresponding relationship between the contact angle γ and the tension variation Tn. If the contact angle γ increases, the tension variation Tn also increases nearly linearly. That is, the tension variation Tn corresponding to the contact angle γ is expressed as the following Eq. (1):

Tn=a₁f₁(γ) (a₁ is a constant) (1)

FIG. 8B illustrates the corresponding relationship between the rigidity G of the web 10 and the tension variation Tn. If the rigidity G increases, the tension variation Tn decreases. It is in inverse proportion to the rigidity G. That is, the tension variation Tn corresponding to the rigidity G is expressed as the following Eq. (2):

Tn=a₂f₂(1/G) (a₂ is a constant) (2)

FIG. 8C illustrates the corresponding relationship between the staggered angle α and the separating angle θ. If the staggered angle α increases, the separating angle θ also increases nearly linearly. That is, the separating angle θ corresponding to the staggered angle α is expressed as the following Eq. (3):

θ=a₃f₃(α) (a₃ is a constant) (3)

FIG. 8D illustrates the corresponding relationship between F·θ (where F is the adhesive force between the upper blanket cylinder 9a and the web 10 and θ is the separating angle) and the tension variation Tn. If the value F·θ increases, the tension variation Tn also increases. That is, when the ink tack t and the paper quality (paper kind) of the web 10 remains the same, the adhesive force F and the separating angle θ (which is an amount relating to the adhesive force F) can be handled as a pair of parameters. The tension variation Tn corresponding to F·θ is expressed as the following Eq. (4):

Tn=a₄f₄(F·θ) (a₄ is a constant) (4)

FIG. 8E illustrates the corresponding relationship between the paper elongation amount L of the web 10 and the tension variation Tn. If the paper elongation amount L increases, the tension variation Tn also increases. That is, the tension variation Tn corresponding to the paper elongation amount L is expressed as the following Eq. (5):

Tn=a₅f₅(L) (a₅ is a constant) (5)

FIG. 8F illustrates the corresponding relationship between the inter-color length L* and the tension variation Tn. If the inter-color length L* increases, the tension variation Tn also increases nearly linearly. That is, the tension variation Tn corresponding to the inter-color length L* is expressed as the following Eq. (6):

Tn=a₆f₆(L*) (a₆ is a constant) (6)

FIG. 8G illustrates the corresponding relationship between the contact amount β and the tension variation Tn. The tension variation Tn has a predetermined minimum value, and if the contact amount β increases or decreases from the minimum value, the tension variation Tn increases. The tension variation Tn corresponding to the contact amount β is expressed as the following Eq. (7):

Tn=a₇f₇(β) (a₇ is a constant) (7)

FIG. 8H illustrates the corresponding relationship between the adhesive force F between the upper blanket cylinder 9a and the web 10 and the printing area ratio Mt of the obverse side of the web 10. If the value Mt increases, the adhesive force F also increases nearly linearly. That is, the adhesive force F corresponding to the printing area ratio Mt is expressed as the following Eq. (8):

F=a₈f₈(Mt) (a₈ is a constant) (8)

FIG. 8I illustrates the corresponding relationship between the surface roughness A of the upper blanket cylinder 9a and the adhesive force F. If the surface roughness A increases (i.e., if the surface of the upper blanket cylinder 9a becomes rougher), the adhesive force F decreases in approximately inverse proportion. That is, the adhesive force F corresponding to surface roughness A of the upper blanket cylinder 9a is expressed as the following Eq. (9):

F=a₉f₉(A) (a₉ is a constant) (9)

FIG. 8J illustrates the corresponding relationship between the staggered angle α and the adhesive force F. If the staggered angle α increases, the adhesive force F decreases in approximately inverse proportion. That is, the adhesive force F corresponding to the staggered angle α is expressed as the following Eq. (10):

F=a₁₀f₁₀(α) (a₁₀ is a constant) (10)

FIG. 8K illustrates the corresponding relationship between the ink tack t and the tension variation Tn. If the ink tack t increases, the tension variation Tn also increases. That is, the tension variation Tn corresponding to the ink tack t is expressed as the following Eq. (11):

Tn=a₁₁f₁₁(t) (a₁₁ is a constant) (11)

The calculator 32 calculates the tension variation Tn that occurs in the web 10, by taking parameters into consideration, using the printing-related information and map data prescribing the corresponding relationships that are stored in the storage device 31.

The storage device 31, as shown in FIG. 9, stores a function of the delamination occurrence probability φ and tension variation Tn (exponential function expressed in Eq. 12) as map data, and the calculator 32 sets the corresponding relationship between the delamination occurrence probability φ and the staggered angle α so that the tension variation Tn, calculated as described later as an amount interrelated to the printing-related information, meets the following Eq. (12):

φ=c·exp(Tn) (where c is a constant) (12)

Based on this corresponding relationship, the calculator 32 calculates an optimum range for the staggered angle α which causes the lamination occurrence probability φ to be a predetermined probability φ₀ or less.

The tension variation Tn is a function of the contact angle γ, rigidity G of web 10, separating angle θ, F·θ (production of adhesive force F and separating angle θ), paper elongation amount L of web 10, inter-color length L*, contact amount β, and ink tack t, and can be expressed as:

Tn∝γ, G, θ, F·θ, L, L*, β, t

The adhesive force F is a function of the printing area ratio Mt of the obverse side of web 10, surface roughness A of the upper blanket cylinder 9a, and staggered angle α, and can be expressed as:

F∝c Mt, A, α

The tension variation Tn can be calculated by giving a suitable weight to each function and adding all functions, using the functions (1) to (11) shown in the map data of FIG. 8.

That is, the tension variation Tn, for example, can be expressed as the following Eq. (13):

Tn=k₁γ+k₂G+k₃θ+k₄F·θ+k₅L+k₆L*+k₇β+k₈t (13)

where k₁ to k₈ are coefficients for weighting each parameter and are suitably set by experiment, etc. Since the parameters are interrelated with one another, the coefficient of a parameter representative of a plurality of parameters may be set to a large value, while the coefficient of the remaining parameters may be set to a small value (or zero).

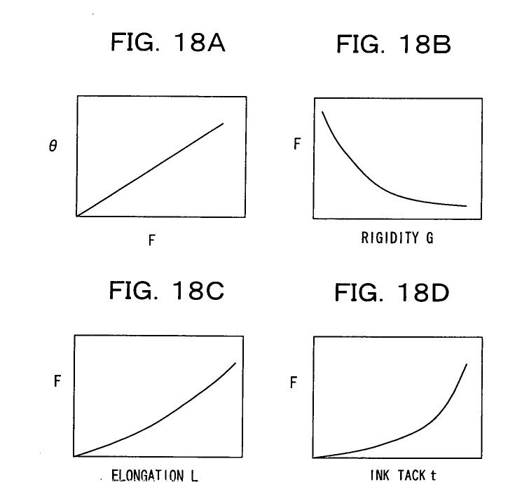

For instance, the printing area ratio Mt of the obverse-side image, paper quality of the web 10 (rigidity G, paper elongation amount L, and if necessary, paper surface roughness), ink tack t, and surface roughness A of the upper blanket cylinder 9a, as printing information, are fixed without being changed at the time of printing. Therefore, as shown in FIGS. 18B to 18D and FIGS. 8H and 8I, employing the maps indicating the corresponding relationship between each of these parameters and the adhesive force, the adhesive forces F corresponding to the parameters Mt, G, L, t, and A input in the storage device 31 are derived, and based on the corresponding relationship between the adhesive force F and the separating angle θ such as the one shown in FIG. 18A, the separating angle θ of the web 10 is assumed.

Note that the separating angle θ is determined by the adhesive force F and total tension T applied in the full width direction of the web 10. The total tension T may be input to the storage device 31 beforehand.

The total tension T may be obtained by installing between the printing units 7 a non-contact type tension sensor such as an acoustic tension sensor, and measuring the total tension of the web 10 between the printing units 7. Alternatively, by measuring tension in the vicinities of the web feeder section 1 and cooling section 52, and calculating the weighted average of the tension near the web feeder section 1 and tension near the cooling section 52, the total tension between the printing units 7 may be set. As a simpler method, either the tension of the web 10 measured near the web feeder section 1 or the tension of the web 10 measured near the cooling section 52 may be employed as the total tension T.

Using the map shown in FIG. 8A, the tension variation Tn is calculated from the separating angle θ assumed; the delamination occurrence probability φ is calculated using the map data shown in FIG. 9; and an optimum range for the staggered angle α is derived.

The blanket cylinders, kind of ink to be used, and inter-color length L* are normally not changed over a long period of time without being interchanged each time printing is performed. Therefore, the adhesive force F may be calculated from the printing area ratio Mi of the obverse-side image and paper quality (rigidity G) of the web 10, based on the assumption that the same surface roughness A of the upper blanket cylinder 9a, ink tack t, and inter-color length L* are always employed.

The corresponding relationships between the parameters and the adhesive force F may be obtained beforehand by experiment, etc. In this case, if the obtained corresponding relationships are stored as a database, a corresponding adhesive force F can be output when the value of each parameter is input.

When the current staggered angle α stored in the storage device 31 is departed from the above-described optimum range, the command device 33 functions to transmit a command signal to the actuator 20 so that the staggered angle α is within the optimum range.

Note that the command device 33 is configured to transmit the above command signal only when particular conditions for the occurrence of delamination are satisfied. Therefore, when the particular conditions are not satisfied, as in the range indicated by an arrow in FIG. 9, the delamination occurrence probability φ is zero or near zero.

The particular conditions are that

(1) Images are transferred to both sides of the web 10,

(2) A difference in printing-area ratio between the printing area ratio data Mt of the obverse side and the printing area ratio data Mb of the reverse side is larger than a preset threshold value,

(3) An obverse-side image contains a nonprinting area; and

(4) That portion of a reverse-side image which corresponds to the nonprinting area of the obverse-side image has a printing area ratio which is a preset value or greater.

When the conditions (1) to (4) are all satisfied, the above particular conditions are satisfied.

In addition to the above (1) to (4), the particular conditions may further include that

(5) both an average of the printing area ratio data Mt of an obverse-side image and an average of the printing area ratio data Mt of a reverse-side image are a first reference value or greater. When the conditions (1) to (5) are all satisfied, the above particular conditions may be satisfied. Alternatively, if the condition (5) is satisfied, the particular conditions may be satisfied, whether the conditions (1) to (4) are satisfied or not.

The above particular conditions may further include that (6) the printing area ratio Mt of an obverse-side image is a second reference value or greater, and (7) the printing area ratio Mb of a reverse-side image is a third reference value or greater. Alternatively, if the conditions (6) and (7) are satisfied, the particular conditions may be satisfied regardless of whether the other conditions have been satisfied.

### (Angle Adjustment Mechanism)

Now, embodiments of the actuator 20 as an angle adjustment mechanism will be described. Although various constructions are considered as embodiments of the actuator 20, some of them will be described.

Referring to FIG. 10, there is shown an embodiment of the actuator 20. Note in the figure that the dimensions of the upper and lower plate cylinders 8a and 8b, blanket cylinders 9a and 9b, and staggered angle α are larger than the actual dimensions of them.

As shown in FIG. 10, the lower portion of the printing unit 7 is provided with a pivot 40 that allows the printing unit 7 to rotate pivotally. The printing unit 7 is pivoted on the pivot 40 by a drive mechanism not shown. This makes it possible to adjust the staggered angle α, as shown by a two-dot chain line.

The drive mechanism can employ a combination of screws and motors, or an air cylinder. It may be any type of drive mechanism if it is able to properly adjust the staggered angle α in response to a command signal from the command device 33 of the controller 30.

Referring to FIG. 11, there are shown other embodiments of the actuator 20.

As shown in FIGS. 11A and 11B, the staggered angle α is adjusted by pivotally rotating plate cylinders 8a and 8b and blanket cylinders 9a and 9b with a drive mechanism not shown, using arms 41 to 43.

In the example shown in FIG. 11A, the lower blanket cylinder 9b is pivotally rotated by the arm 41 attached to or near the center of the upper blanket cylinder 9a, and the lower plate cylinder 8b is pivotally rotated by the arm 42 so it follows the pivotal movement of the lower blanket cylinder 9b.

In the example shown in FIG. 11B, the lower blanket cylinder 9b and lower plate cylinder 8b are pivotally rotated as one body by the arm 43.

With the constructions described above, it is possible to set a proper staged angle α in response to a command signal from the command device 33.

### (Effects)

Since the offset rotary printing machine and angle adjustment method according to the first embodiment of the present invention are constructed as described above, an optimum range for the staggered angle α can be calculated by directing attention to the tension variation Tn which interrelates with parameters associated with printing-related information which vary each time printing is performed, such as the printing area ratio data Mt and Mb of obverse-side and reverse-side images which vary with the image kind used, ink tack t which varies with the kind of each color used (ink tack t which varies according to ink manufactures), rigidity G which varies with the kind of web 10 used, etc. By adjusting the staggered angle α according to the calculated optimum range so that the delamination occurrence probability φ is a predetermined probability or less, the first embodiment of the present invention is capable of reliably preventing the occurrence of delamination.

In addition, the staggered angle α is adjusted only when the particular conditions in which delamination can occur are satisfied. Therefore, for example, as in the case where only one side of the web 10 is printed, when no delamination occurs, the staggered angle α is not adjusted. Accordingly, wasteful control can be reduced.

Besides, by previously selecting the material of the web 10 and kind of ink that are advantageous in suppressing delamination, the occurrence of delamination can be more reliably prevented.

### Second Embodiment

Now, a second embodiment of the present invention will be described. This embodiment is the same as the first embodiment, except a sound pressure sensor (noise sensor) and a control method by a controller. The same parts as the first embodiment are given the same reference numerals for avoiding redundancy.

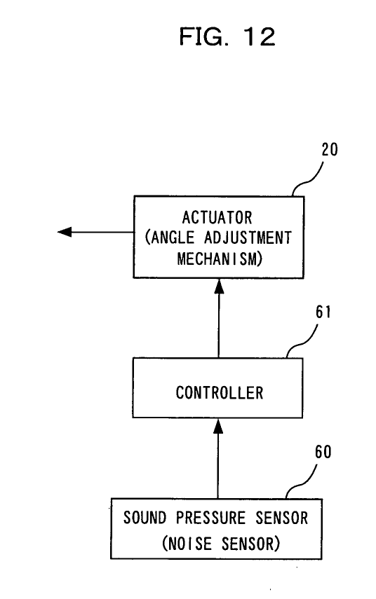

As shown in FIG. 12, in the second embodiment, a sound pressure sensor noise sensor 60 is connected to the input side of a controller 61.

The sound pressure sensor 60 functions to measure a noise level (sound pressure level) that occurs in the printing cylinders (particularly, upper blanket cylinder 9a) of each of the printing units 7, and input the result of measurement to the controller 61.

That is, it has been found that in the case where the tension variation Tn of the web 10 is great, great noise occurs due to a variation in the separating position of the web 10 and therefore the probability of delamination occurrence is interrelated to a noise level caused by printing. The greater the noise level, the higher the probability of delamination occurrence.

Hence, the controller 61 handles input noise level information as a parameter interrelated to the delamination occurrence probability φ and, when the probability φ is a predetermined threshold value or greater, controls an angle adjustment mechanism (actuator) 20 to adjust the staggered angle α so that the noise level information is reduced.

The controller 61 is constructed such that only when a signal indicating a printing adjustment stage (e.g., a stage from the start of printing to the completion of the color checking of an image to be printed) is input, it transmits a command signal to the actuator to adjust the staggered angle α.

The offset rotary printing machine and inclination setting method according to the second embodiment of the present invention are constructed as described above. Accordingly, based on the noise level created by the printing cylinder at the time of printing, the staggered angle α can be accurately adjusted according to the operating state of the printing machine, whereby the occurrence of delamination can be more effectively reduced.

In addition, when the noise level is too great, the level is reduced and therefore noise associated with the printing operation can also be reduced.

Besides, since the staggered angle α is adjusted in the printing adjustment stage, a reduction in the efficiency of the printing operation due to adjustments to the staggered angle α can be reduced.

### Other Embodiments

While the present invention has been described with reference to the preferred embodiments thereof, the invention is not to be limited to the details given herein, but may be modified within the scope of the invention hereinafter claimed.

For example, in the above-described embodiments, while printing-related information and noise level have been employed as parameters interrelated with the probability of delamination occurrence, the present invention is not limited to these parameters. It may employ any parameter, so long as it interrelates with the probability of delamination occurrence.

What is claimed is:

1. An offset rotary printing machine which includes a first printing cylinder and a second printing cylinder in which printing is performed on a web at a nip between the pair of printing cylinders,
the second printing cylinder contacting the first printing cylinder and being shifted downstream from the first printing cylinder, said printing machine comprising;
an angle adjustment mechanism for adjusting an angle of imaginary oblique plane, which is inclined with imaginary perpendicular plane being perpendicular to the moving direction of the web and is connecting between each center axis of the first printing cylinder and the second printing cylinder; and
A controller for controlling said angle adjustment mechanism, based on parameters interrelating to a delamination occurrence probability that is caused as printing is performed by the second printing cylinder.

2. The offset rotary printing machine as set forth in claim 1, wherein said controller comprises
corresponding-relationship setting part for setting a corresponding relationship between the delamination occurrence probability and the angle, based on printing-related information equivalent to the parameters which includes information on images to be printed, information on ink used, information on property of the web, and information on a support span of the web located downstream of the second printing cylinder;
optimum-range calculator for calculating an optimum range for the angle which causes the delamination occurrence probability to be a preset probability or less, based on the corresponding relationship that was set by said corresponding-relationship setting part; and
command part for outputting a command signal to said angle adjustment mechanism to cause the angle to be within the optimum range calculated by said optimum-range calculator.

3. The offset rotary printing machine as set forth in claim 2, wherein
the image information includes a second printing area ratio of a second image that is transferred by the second printing cylinder, and a first printing area ratio of a first image that is transferred by the first printing cylinder;
the ink information includes information on ink tack;
the web-property information includes information on rigidity of the web;
the support span information includes information on an inter-color length which is a distance between the nip of the pair of printing cylinders and a next nip of a next pair of printing cylinders adjacent to the pair of printing cylinders; and
said corresponding-relationship setting part sets, as an amount interrelating to the printing-related information, a tension variation amount in a paper plane which indicates a variation in tension in a width direction of the web on a downstream side of the nip of the pair of printing cylinders, and also sets the corresponding relationship so that the tension variation amount satisfies
φ=c·exp(Tn)
where φ represents the delamination occurrence probability, c represent a constant, and Tn represents the tension variation amount.

4. The offset rotary printing machine as set forth in claim 3, wherein the tension variation amount is a function of a web separating angle which is an angle interrelating to the second printing area ratio of the second image, the ink tack, and the angle and which is an angle of the web to a surface of the second printing cylinder formed as the web is separated from the surface; the rigidity of the web; the printing area ratio of the second image; and a contact amount of the web to a surface of the first printing cylinder which is an amount corresponding to the angle.

5. The offset rotary printing machine as set forth claim 1, wherein said controller controls said angle adjustment mechanism under particular conditions in which delamination can occur.

6. The offset rotary printing machine as set forth in claim 5, wherein the particular conditions are that the first and second images are transferred to both sides of the web; a difference between the first printing-area ratio and the second printing area ratio is a preset threshold value or greater; the second image to be transferred by the second printing cylinder contains a nonprinting area; and a portion of the first image which corresponds to the nonprinting area of the first image has a printing area ratio which is a preset value or greater.

7. The offset rotary printing machine as set forth in claim 5, wherein the particular conditions are that both an average of the first printing area ratio of the first image and an average of the second printing area ratio of the second image are a first reference value or greater.

8. The offset rotary printing machine as set forth claim 5, wherein the particular conditions are that the second printing area ratio of the second image is a second reference value or greater, and a printing area ratio of a portion of the first image is a third reference value or greater.

9. The offset rotary printing machine as set forth in claim 1, further comprising:
noise sensor for sensing, as a parameter interrelating to the delamination occurrence probability, a noise level that is generated as printing is performed by the pair of printing cylinders;
wherein, based on the noise level sensed by noise sensor, said controller controls the angle adjustment mechanism to adjust the angle so that the noise level is reduced.

10. The offset rotary printing machine as set forth in claim 9, wherein said controller adjusts the angle based on the noise level at an adjustment stage before printing is performed by the pair of printing cylinders.

11. A method of adjusting an angle of imaginary oblique plane, which is inclined with imaginary perpendicular plane being perpendicular to the moving direction of a web and is connecting between each center axis of an first printing cylinder and an second printing cylinder,
the pair of printing cylinders being equipped with an offset rotary printing machine printing on the web at a nip between the pair of printing cylinders,
the second printing cylinder contacting the first printing cylinder and being shifted downstream from the first printing cylinder, said method comprising:
an information acquisition step of acquiring, as parameters interrelating to a delamination occurrence probability that is caused as printing is performed by the second printing cylinder, printing-related information which includes information on images to be printed, information on ink used, information on property of the web, and information on a support span of the web located downstream of the second printing cylinder;
a corresponding-relationship setting step of setting a corresponding relationship between the delamination occurrence probability and the angle, based on the information acquired by said information acquisition step; and
an angle setting step of setting the angle to a range which causes the delamination occurrence probability to be a preset probability or less, based on the corresponding relationship that was set by said corresponding-relationship setting step.

12. The method as set forth in claim 11, wherein
the image information includes a second printing area ratio of a second image that is transferred by the second printing cylinder, and a first printing area ratio of a first image that is transferred by the first printing cylinder;
the ink information includes information on ink tack;
the web-property information includes information on rigidity of the web;
the support span information includes information on an inter-color length which is a distance between the nip of the first pair of printing cylinders and a next nip of a next pair of printing cylinders adjacent to the first pair; and
said corresponding-relationship setting step sets, as an amount interrelating to the printing-related information, a tension variation amount in a paper plane which indicates a variation in tension in a width direction of the web on a downstream side of the nip of the pair of printing cylinders, and also sets the corresponding relationship so that the tension variation amount satisfies
φ=c·exp(Tn)
where φ represents the delamination occurrence probability, c represent a constant, and Tn represents the tension variation amount.

13. The method as set forth in claim 12, wherein the tension variation amount is a function of a web separating angle which is an angle interrelating to the second printing area ratio of the second image, the ink tack, and the angle and which is an angle of the web to a surface of the second printing cylinder formed as the web is separated from the surface; the rigidity of the web; the printing area ratio of the second image; and a contact amount of the web to a surface of the first printing cylinder which is an amount corresponding to the angle.

14. The method as set forth claim 11, further comprising:
a property selection step of selecting at least either the property of the web or the kind of ink used, based on a corresponding relationship between at least either the property of the web or the kind of ink used and the delamination occurrence probability, prior to said information acquisition step.

15. A method of adjusting an angle of imaginary oblique plane, which is inclined with imaginary perpendicular plane being perpendicular to the moving direction of a web and is connecting between each center axis of an first printing cylinder and an second printing cylinder,
the pair of printing cylinders being equipped with an offset rotary printing machine printing on the web at a nip between the pair of printing cylinders,
the second printing cylinder contacting the first printing cylinder and being shifted downstream from the first printing cylinder, said method comprising:
a noise sensing step for sensing, as a parameter interrelating to a delamination occurrence probability that is caused as printing is performed by the second printing cylinder, a noise level that is generated as printing is performed by the pair of printing cylinders; and
an angle adjustment step which, based on the noise level sensed by noise sensing step, adjusts the angle so that the noise level is reduced.

16. The method as set forth in claim 15, wherein the angle adjustment step is carried out at an adjustment stage before printing is performed by the pair of printing cylinders.
